(19) United States
(12) Patent Application Publication
(10) Pub. No.: US 2014/0109777 A1
(43) Pub. Date: Apr. 24, 2014

(54) PRESSURE DEVICE

(71) Applicant: Li-Tec Battery GmbH, Kamenz (DE)

(72) Inventor: Frank Pantke, Biehla (DE)

(73) Assignee: LI-TEC BATTERY GMBH, Kamenz (DE)

(21) Appl. No.: 14/058,754

(22) Filed: Oct. 21, 2013

Related U.S. Application Data
(60) Provisional application No. 61/716,649, filed on Oct. 22, 2012.

(30) Foreign Application Priority Data
Oct. 22, 2012 (DE) 102012020694.1

(51) Int. Cl. B30B 15/04; H01M 4/04

(52) U.S. Cl. CPC B30B 15/045; H01M 4/043
USPC 100/99; 29/407.1

(57) ABSTRACT

A pressure device for use in the production of electrochemical energy storage devices is designed to bring a force to bear on a first foil section of said energy storage device during said production and includes a thrust bearing element, a pressure element, a fastening element that is designed for fastening the pressure element to the thrust bearing element, and an aligning element, wherein at least parts of said pressure element are separated from said thrust bearing element by said aligning element, wherein said aligning element can be connected in form-fit manner to said pressure device.

### CROSS-REFERENCE TO RELATED APPLICATIONS

The present application claims the benefit of U.S. Provisional Patent Application Ser. No. 61/716,649, filed Oct. 22, 2012, the entire content of which is incorporated herein by reference. The present application also claims priority to German Patent Application 10 2012 020 694.1, filed Oct. 22, 2012, the entire content of which is incorporated herein by reference.

### DESCRIPTION

Most electrochemical energy storage devices have a reactive, electrochemically active part for storing energy and a passive part whose main function is to protect the active part. The active part is often referred to as the electrode stack, and it is usually insulated from the surrounding environment by a protective casing, (the passive part). This not only prevents the electrode stack from becoming contaminated, it also helps to avoid unintended interaction between the electrode stack and the surrounding environment. The electrochemically active part is insulated from the surrounding environment in gas-impermeable manner by the casing. The casing frequently has a film-like structure and comprises a weldable material. Since the electrochemically active part is inserted in this casing when the energy storage device is manufactured, the casing usually has an opening or is produced from a plurality of individual parts, with the result that the casing more often than not includes at least one weld site. In this branch of technology, welds often represent a critical zone in terms of mechanical strength or impermeability. Consequently, this weld site in the casing frequently has important implications for the insulation of the electrochemically active part.

In order to ensure that such casings are sealed reliably, it is typically necessary to heat sections thereof and to apply a force to the sections of the casing that are to be joined farther along the weld site. In this context, the quality of the weld is affected by many factors, also including the way in which heat is applied for warming and the method by which the pressure is brought to bear. Even if the seal is created by introducing an additive, such as is typical in the case of adhesive bonds, this application of force is still of the utmost significance. A high quality weld is typically achieved when suitable conditions for joining the sections of the casing are present along the entire length of the weld, particularly if the force is applied uniformly and even pressure is created along the entire length of the weld. In order to achieve this even pressure, a tool is usually provided in which the casing is clamped along the weld site during sealing. This clamping is often assured by a device known as a sealing bar on the tool, wherein the sealing bar presses the casing against a second sealing bar or against another surface, which is usually flat. In order to achieve the usually even pressure distribution along the weld site of the casing, this sealing bar is most often aligned with respect to the second sealing bar or the flat surface. This alignment is carried out before the tool is put into operation and is frequently very time-consuming. The alignment itself is typically carried out by placing thin metal strips or the like under the sealing bar. Moreover, this alignment often causes the formation of a gap between the sealing bar and the device for supplying heat for warming the casing, which gap hinders the transfer of heat from the heat supplying device to the sealing bar, and thus also degrades the effectiveness of the entire system.

Hot sealing systems with alignable sealing bars are known from the prior art, the document U.S. Pat. No. 2,589,756 describes such as system. The intended purpose of this system is to make it possible to seal different plastic bags in one installation. This object is achieved with multipurpose, adjustable tools and through the use thereof in a corresponding hot sealing system. In this system, the heater elements are accommodated in a mounting device. The actual sealing bar is disposed on this mounting device. It is fastened to the mounting device with screws in such manner that the sealing bar is able to expand longitudinally with respect to the mounting device without any mechanical stress because the screws are inserted in elongated holes. The mounting device may be adjusted with respect to the thrust bearing device by means of a plurality of screws so that uniform contact is assured between the sealing bar and its counterpart.

The problem addressed by the invention is to provide an improved pressure device that in turn will improve productivity in the production of electrochemical energy storage devices. This problem is solved with an object according to the teaching of the claim 1 and a working method according to claim 12, advantageous refinements are the object of the dependent claims.

For the purpose of the present invention, the term pressure device is understood to refer to an apparatus that is used in the production of electrochemical energy storage devices for the complete or partial sealing of a casing of an electrochemically active part of said device. During production of said electrochemical energy storage device, a compressive force is applied to said casing, preferably to a first foil section thereof, via this pressure device. In order to bring this force to bear, this pressure device comprises a thrust bearing element and a pressure element. The pressure element is preferably arranged in such manner that it is braced against the thrust bearing element. Said pressure element also comprises a fastening element. This fastening element is designed to fasten the pressure element to the thrust bearing element. In order to realise the fastening effect, the fastening element preferably exerts a clamping force on said pressure element and said thrust bearing element. The pressure element is designed substantially as an elongated body and has a cross sectional area and a longitudinal extension orthogonal thereto, the dimensions of the cross-sectional area being small compared with the longitudinal extension. Said pressure device further comprises an aligning element, and at least sections of said pressure element are separated from said thrust bearing element by said aligning element. According to the invention, the aligning element and the pressure device are joined in a form-fit connection.

For the purposes of the invention, the term casing is understood to mean a device that at least partly, preferably essentially completely encloses an electrochemically active part of the energy storage device, preferably the electrode stack. The casing preferably comprises a material with foil-like construction. The thickness of said material is preferably low compared with the other spatial dimensions thereof. Also preferably, said material is flexible, so that may be adapted easily to the contour of the electrode stack. The material of the casing preferably comprises a plurality of layers, particularly preferably at least two. One of the two layers is preferably a weldable layer; said layer particularly preferably has thermoplastic properties. Also preferably, a second layer is designed to insulate the casing and preferably comprises metal components.

For the purposes of the invention, the term electrochemically active part is understood to mean a part of the energy storage device that is designed to convert electrical energy for storage as chemically bound energy, or to release it again. This part preferably comprises a plurality of electrodes, wherein lithium ions constitute at least one component of said electrodes.

For the purposes of the invention, the term application of a force to a foil zone of the casing is understood to mean that preferably two foil zones are pressed against one another via the pressure device, preferably in the area of a weld site. A force normal to the surface of these foil zones is preferably generated via the pressure device. The force is also preferably generated along a line, or along the weld site of the casing that is to be sealed. The application of said force is also preferably accompanied by the introduction of a temperature increase in at least one foil zone. Said temperature increase is preferably designed such that the temperature in said foil is substantially equal to the melting point of the weldable material of the casing, temperature increase is thus preferably dependent on the material properties of the casing, particularly the melting temperature thereof.

For the purposes of the invention, the term pressure element is understood to mean a device that brings the pressure to bear on the foil zone, preferably directly. A pressure element is preferably understood to refer to a sealing bar. Also preferably, the pressure element is understood to be an elongated component. For the purposes of the present invention, an elongated component is understood to refer to a component in which the component extends in a lengthwise direction normal to its cross-sectional area, wherein the dimensions of the cross-sectional area are small compared with said lengthwise extension, wherein for the present purposes small is understood to be a dimension that is essentially equal to or smaller than half the lengthwise extension. Also preferably, the pressure element is arranged on a thrust bearing element.

For the purposes of the present invention a thrust bearing element is understood to be an element against which the pressure element is braced when the pressure element exerts a force on the foil zone. Also preferably, the pressure device comprises a fastening element.

For the purposes of the invention, a fastening element is understood to be an element that is designed to fasten the pressure element to the thrust bearing element. Also preferably, the fastening element exerts a clamping force in order to fasten the pressure element to the thrust bearing element. Also preferably, said fastening element is in the form of a screw element, a tie rod element or the like. The fastening element preferably exerts a clamping force on the pressure element and the thrust bearing element. Besides said fastening element, said pressure device also comprises an aligning element.

For the purposes of the invention, an aligning element is understood to be an element for aligning the pressure element, wherein said aligning element preferably exerts a force on the pressure element in a direction orthogonal to the lengthwise extension of the pressure element. Said aligning element is preferably braced against the thrust bearing element in order to bring said force to bear. Also preferably, the force applied by the aligning element is brought to bear in the opposite direction to the force brought to bear by the fastening element. The aligning element is preferably able to influence the course of a notional line that passes through a centre of gravity of the cross-sectional area of the pressure element and also extends orthogonally to said cross-sectional area. Thus, it is preferably possible to influence the course of the force application along the weld site of the casing by altering the course of said notional line. The pressure element is preferably aligned in such manner that said notional line is not only a straight line but also extends parallel to the casing that will be sealed by the pressure device. With such an alignment of the pressure element, a substantially even force is applied to the casing by the pressure element when the casing is sealed, and uniform seam quality is thus also obtained. In this context, it may preferably be assumed that said notional line extends parallel with and at a constant distance from the surface with which the pressure element is in contact with the casing during sealing. Also preferably, the pressure element is aligned such that said notional line is not straight. With such an alignment, it is advantageously possible to ensure that the same force is applied to the casing at points where it is intended for certain elements to protrude through the casing from the inside to the outside, such as a current conductor or the like, at points where this is not the case, thereby ensuring even seam quality. Also preferably, such a setting of said notional line that deviates from a straight course may be used to provide a prêt ermined rupture points in the weld site of the casing during sealing thereof. The force that is applied to the pressure element via the aligning element is preferably so great that the pressure element is separated at least in areas from the thrust bearing element. In order to align the pressure element, the aligning element and the pressure device are joined in a form-fit connection. This form-fit connection makes it possible for the aligning element to remain on the thrust bearing element or the pressure element even if one of these elements is removed. Compared with alignment with shims, levelling plates or strips or the like, the advantage of this is that the alignment is hardly affected, if at all, by the removal/assembly process, and consequently an improved pressure device is produced.

For the purposes of the invention, a method according to the invention for aligning the pressure element in the pressure device according to the invention comprises the following steps: Recording a starting position of the pressure element, altering said starting position by operating at least one aligning element until a reference position of the pressure element is reached, fixing the aligning element in this reference position.

For the purposes of the invention, recording the starting position is understood to mean particularly calculating the spatial position of the pressure element, preferably of a reference surface thereof, and particularly preferably of a contact surface of the pressure element with which it is in contact with the casing of the energy storage device, when said casing is sealed. This position is preferably determined quantitatively by means of contact measurement procedures, particularly based on a measuring probe or by contactless means, particularly based on optical or electrical measuring methods. Also preferably, the position is determined qualitatively, particularly by colour transfer procedures or by the preparation of a negative impression of the pressure element in a suitable material therefor, which material may also be the casing of one of said energy storage devices itself.

For the purposes of the invention, the term altering said starting position is understood to mean that, preferably starting from the recorded position, the spatial position of the pressure element is altered by means of the aligning element in such manner that a specifiable target position thereof is reached. The recording of the starting position and the alteration of the starting position are preferably repeated in alternating sequence until the target position of the pressure element is reached.

For the purposes of the invention, the term fixing the aligning element is understood to mean that the aligning element is immobilised at its current position, corresponding to the target position, by means of a locking device when the pressure element reaches the target position, so that the aligning element cannot be moved unintentionally. The term fixing the aligning element is preferably understood to mean that a first threaded element, particularly a locknut, is mounted on a second threaded element, particularly a screw element, is tightened flush with a stop element, wherein said stop element is particularly arranged on an element into which the screw element is screwed, thereby preventing the aligning element from moving.

In a preferred embodiment, the aligning element and the thrust bearing element are joined in a form-fit connection. With a form-fit connection with the thrust bearing element, the pressure element can be detached from the thrust bearing element without directly altering the position of the aligning element. In another preferred embodiment, the aligning element is seated in the thrust bearing element by means of a threaded section. Also preferably, the aligning element transmits the force to the pressure element in a preferably flat contact surface. Also preferably, this contact surface is orientated orthogonally to a centre line of said threaded section. With a pressure device designed in this manner, it is advantageously possible to adjust the aligning element with respect to the thrust bearing element so that a predetermined force is exerted on this foil zone when the casing is sealed, and that this setting is retained even when the pressure element is detached from the thrust bearing element and mounted thereon again. Moreover, the alignment of the pressure element is advantageously simplified thereby.

In a preferred embodiment, the aligning element is joined with the pressure element in a form-fit connection. With a form-fit connection with the pressure element, the pressure element can be detached from the thrust bearing element without directly altering the position of the aligning element. In a further preferred embodiment, the aligning element is seated in the pressure element by means of a threaded section. Also preferably, the aligning element transmits the force to the thrust bearing element in a preferably flat contact surface. Also preferably, this contact surface is orientated orthogonally to a centre line of said threaded section. With a pressure device designed in this manner, it is advantageously possible to adjust the aligning element in the thrust bearing element so that a predetermined force is exerted on this foil zone when the casing is sealed, and that this setting is retained even when the pressure element is detached from the thrust bearing element and mounted thereon again. Moreover, the alignment of the pressure element is advantageously simplified thereby.

In a preferred embodiment, said aligning element comprises a first flat section, which cooperates with said pressure element, and a second flat section, which cooperates with said thrust bearing element. Also preferably, the aligning element comprises an actuating element. The distance between said first flat section and said second flat section is preferably alterable by a movement, particularly a rotary movement of said actuating element. The actuating element preferably comprises a “key surface”, preferably a section with an external or internal polygonal profile, particularly preferably an external or internal hexagonal or rectangular shape. Altering the distance of the first flat section from the second flat section by means of a rotary movement enables the alignment of said pressure element to be carried out particularly simply and precisely, since rotary movements are particularly easy to execute and check.

In a preferred embodiment, the aligning element comprises a threaded section, a first surface section, and a bracing section, a second surface section. Also preferably, said aligning element is in the form of a kind of screwing device, with a cylindrical section that comprises said threaded section and a section that is designed to transmit a torque and is to be considered the actuating element. Also preferably, the bracing section is arranged orthogonally to a notional centre line of this threaded section. The threaded section is preferably in form-fit engagement with the pressure element or the thrust bearing element, the bracing section is braced either directly or indirectly against the respective other of the two elements. The phrase indirectly braced against the respective other element has to be understood to mean that said bracing is provided by means of another element, particularly to improve a pressing force distribution in a contact surface. Due to the design of the aligning element with a threaded section, it is possible to ensure a simple method of aligning the pressure element.

In a preferred embodiment, the aligning element has a first and a second cylindrical section, the two cylindrical sections being arranged eccentrically with respect to one another. An aligning element of such kind is preferably constructed in an eccentric arrangement. Also preferably, the first cylindrical section of such an eccentric arrangement is mounted rotatably in said pressure element or said thrust bearing element. Also preferably, the second cylindrical section is either indirectly or directly braced against the respective other element. In this context, the phrase indirectly braces has preferably to be understood to mean that at least parts of the second cylindrical section are seated inside one of the elements, which on the one hand has a negative form of the cylinder, that is to way a concave recess, and on the other hand also has a shape that is adapted to the surface on which it is supported, preferably a flat surface. This variant makes it possible for the pressure element to be aligned particularly easily, simply by turning the eccentric arrangement and it also represents a simple design. Moreover, in the case of indirect bracing of the pressure element, a contact surface can be enlarged.

In a preferred embodiment, the aligning element comprises a wedge element. This wedge element preferably comprises a first wedge surface, a second wedge surface and a wedge support surface. The first wedge surface is preferably in contact with the second wedge surface. Also preferably, the first and second wedge surfaces are arranged in such manner that when they moved toward one another, the position of the wedge support surface is shifted, preferably in the direction of the alignment. The wedge support surface is preferably in indirect or direct contact with the pressure element or the thrust bearing element. Shifting the first and second surfaces causes the wedge support surface to exert a force on the element with which it is in contact, and in this way the position of the pressure element relative to the thrust bearing element may be changed. Also preferably, the first or the second, or the first and the second wedge surfaces are furnished with a friction-reducing coating, in particularly such a coating comprises bronze or PTFE, more preferably the coating consists of one of these materials. Also preferably, the wedge support surface is also furnished with such a coating. Also preferably, the first and second wedge surfaces are inclined more than 1°, preferably more than 5° and particularly preferably more than 15° relative to the wedge support surface, and also preferably, said surfaces are inclined by less than 60°, preferably less than 30° and particularly preferably less than 20°. A force is preferably exerted via a screw element on a component that comprises said first wedge surface in order to shift said first wedge surface relative to said second wedge surface. Also preferably, the ratio between the pitch of the screw element and the inclination of said first and second wedge surfaces is selected such that for one full turn of the screw element the wedge support surface moves toward the pressure device by an integer multiple of 1/1000 mm, preferably by an integer multiple of 1/100 mm and particularly preferably of 1/10 mm. Such a variant of the pressure device enables particularly precise alignment of the pressure element and at the same time a particularly rigid support of the pressure element due to the areal contact thereof with the wedge surface sections.

In a preferred embodiment, the aligning element comprises a lever device. Said lever device is preferably attached to the pressure element or the thrust bearing element with a swivel joint. Also preferably, the aligning element comprises a lever device with two lever elements, one of which is attached with a swivel joint indirectly or directly to the thrust bearing element and the other is attached with a swivel joint indirectly or directly to the pressure element. Also preferably, a lever element of the aligning element comprises a lever support surface, and the lever support surface is braced indirectly or directly on the other of the two elements. The term supported indirectly with a swivel joint is understood to mean that the swivel joint is mounted on a bearing unit, which itself is supported by a preferably flat contact with the thrust bearing element or the pressure element. Also preferably, a force is exerted on the aligning element to align the pressure element, and this force is preferably applied to at least one lever element of said aligning element via a screw element. Also preferably, this force is applied to the end of a lever element that is opposite the swivelling support thereof on the thrust bearing element or pressure element or on the support unit. Also preferably, two lever elements are connected to one another via a swivel joint, and force for aligning the pressure element is transferred to the lever device at that swivel joint. The aligning element is preferably arranged in such manner that at least one of the lever elements, preferably both lever elements, are aligned substantially orthogonally with the direction of longitudinal extension of the pressure element when the pressure element is aligned via the aligning element. In order to align the pressure element, the angular position of the lever elements with respect to the direction of longitudinal extension of the pressure element may be altered. The phrase substantially orthogonal alignment of at least one lever element has preferably to be understood to mean that the gradient of a notional line through a centre of rotation of the lever element and along the extension of the lever element is greater than 0°, preferably greater than 1° and particularly preferably greater than 2°, and preferably less than 30°, more preferably less than 20°, and particularly preferably less than 10° relative to the longitudinal extension of the pressure element. Such an almost orthogonal alignment of at least one of said lever elements enables a particularly rigid and at the same time precise alignment of the pressure element, since a slight change in the angle of one of said lever elements only causes a small position change in a direction orthogonal to the longitudinal extension of the pressure element.

Also preferably, one of said lever elements comprises a lever support surface, wherein said lever support surface is braced on the thrust bearing element or the pressure element. The lever element is preferably mounted so as to be rotatable in a mounting device, and said support surface is arranged on the mounting device. With this mounting device with the lever support surface, the contact area for the lever element is enlarged which thus ensures improved transmission of force.

In a preferred embodiment, the aligning element comprises a detent device. Said detent device is designed in such manner as to prevent the actuating element from rotating the aligning element. Said detent device is preferably equipped with a pin and bolt connection, also preferably a threaded bolt and locknut connection or the like. The detent device is particularly preferably in the form of a locknut on the threaded section of the aligning element. By preventing the actuating element from rotating the aligning element it is advantageously ensured that the position of the aligning element and therewith the alignment of the pressure element also cannot be altered unintentionally.

In a preferred embodiment, the pressure element comprises a temperature control device. Preferably said temperature control device is situated mostly or entirely inside the pressure element. Also preferably, the part of a temperature control device that normally changes its temperature during a temperature control process initiated by said temperature control device is situated mostly or entirely inside the pressure element. Also preferably, the temperature control device is in contact at least with parts of the pressure element. The arrangement of the temperature control device in the pressure element avoids the formation of a gap between or a zone of inefficient heat transfer from the temperature control device to the pressure element when the pressure element is aligned with the thrust bearing element, and thus represents an improved design of the pressure device. Also preferably, one, two or more temperature control devices are situated inside the pressure element. Also preferably, said temperature control devices are controllable separately from each other, so that a temperature profile may be set in targeted manner along the length of the weld site. With the creation of a suitable temperature profile, which is also not adversely affected by areas of poor heat transfer due to the alignment of the pressure element, it is possible to produce weld seams of exceptionally high quality, and on this basis an improved pressure device is provided.

Further advantages of the teaching according to the invention will be explained in the following with reference to the figures, some of which are diagrammatic, and in conjunction with the description of said figures, wherein:

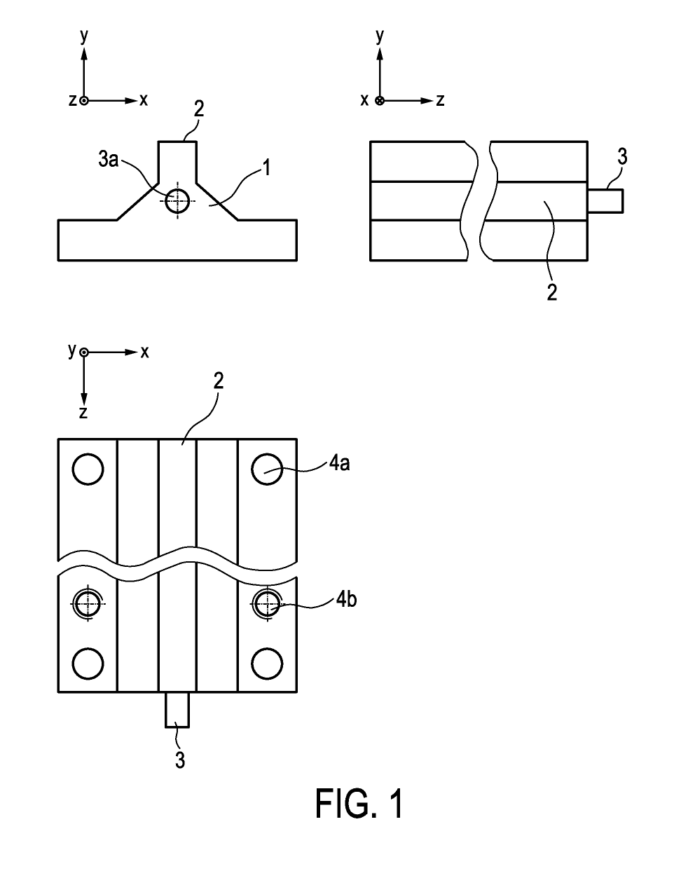

FIG. 1: shows various views (front, side and plan view) of a pressure element with temperature control device situated therein,

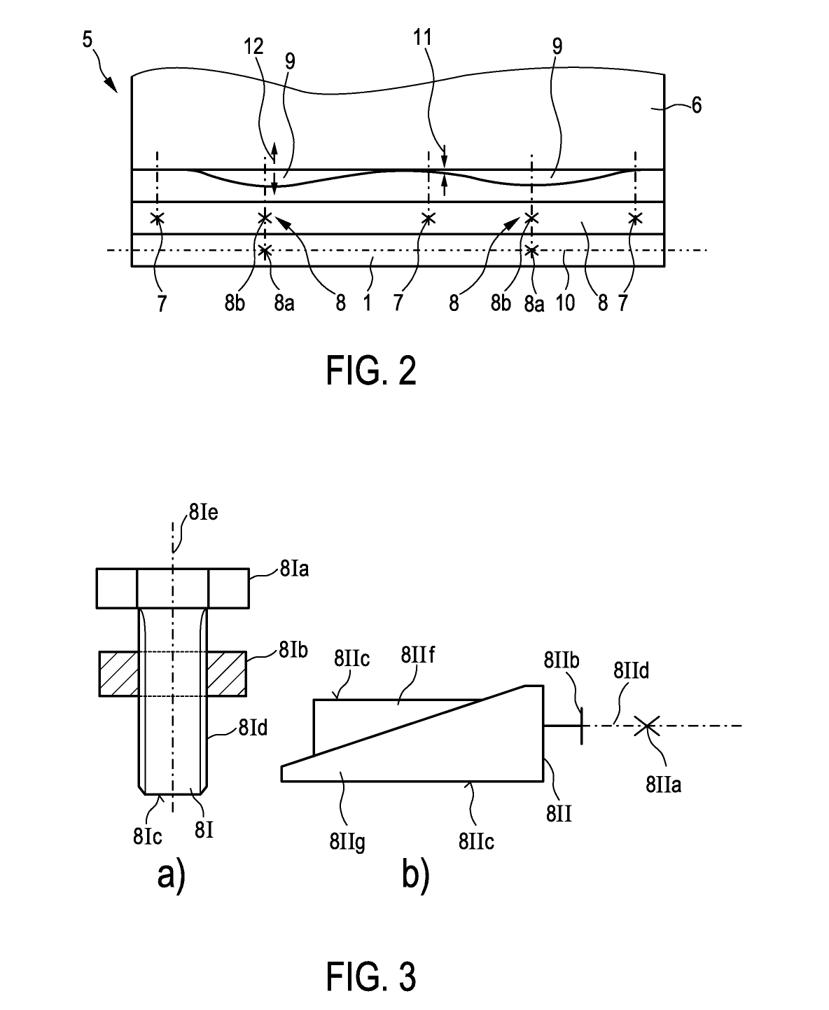

FIG. 2: shows a pressure element, a thrust bearing element, also fastening elements and aligning elements,

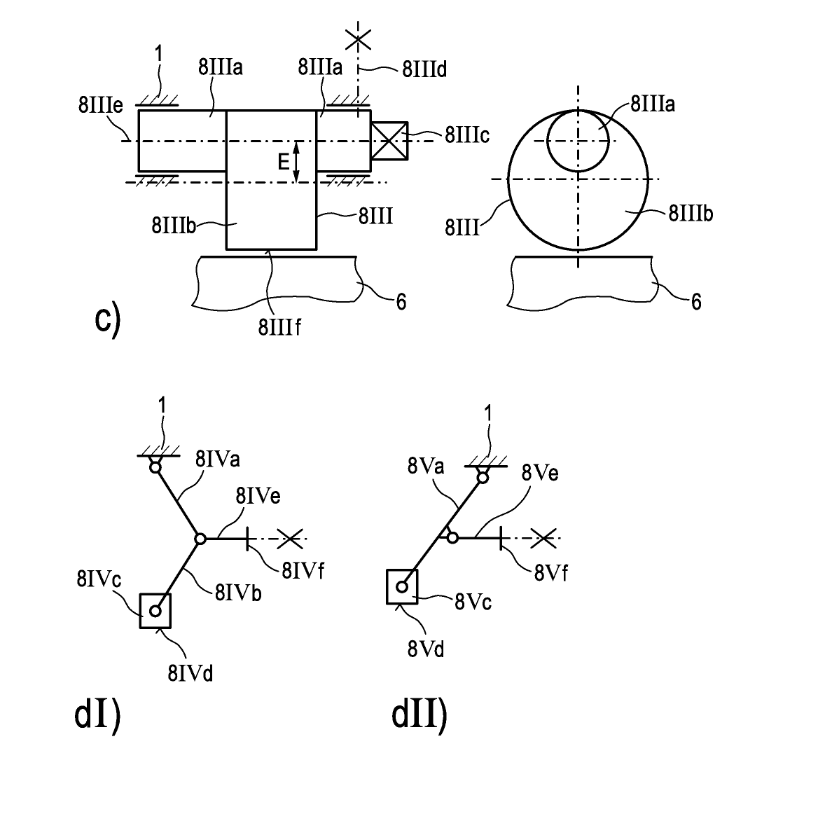

FIG. 3: shows various aligning elements.

FIG. 1 shows front, side and plan views of a pressure element 1, also referred to as a sealing bar. Sealing bar 1 has a pressing surface 2, via which the sealing bar is in contact with the casing of the energy storage device (not shown) and exerts a force thereon during the sealing process. Sealing bar 1 has a flat cross-sectional area in the yx plane and extends longitudinally in the z direction. Sealing bar 1 is heating for sealing the casing, particularly up to the melting temperature of a thermoplastic plastic, by a temperature control device 3 that is seated in a recess 3a, said thermoplastic plastic being a component of the casing. The combined effects of heat and pressure cause the casing to be welded, and the result of the welding operation also depends on the application of the pressing force. Sealing bar 1 comprises various recesses 4a, 4b. These recesses 4a are in the form of drillholes or drilled slots, wherein a drilled slot allows the sealing bar to expand as a result of changes in temperature. Recesses 4a are created for the purpose of accommodating a fastening element (not shown). Recesses 4b are provided to accommodate an aligning element (not shown). In this case, recesses 4b are furnished with a thread and accommodate a screw-like aligning element. With the fastening elements (not shown) and the aligning elements (not shown) it is possible to apply forces in opposite directions, thereby enabling alignment in the y-direction. The alignment of the sealing bar in this direction is very important for the quality of the weld site, because the force is brought to bear on the casing in the same direction during sealing.

FIG. 2 shows a pressure device 5, in this case comprising a sealing bar 1 and a thrust bearing element 6. Sealing bar 1 is fastened to thrust bearing element 6 via a plurality of fastening elements 7. Sealing bar 1 is aligned along a notional line, in this case a straight line 10, by means of a plurality of aligning elements 8. In this process, gaps 9 may form between thrust bearing element 6 and sealing bar 1, and these hinder the transmission of heat from thrust bearing element 6 to sealing bar 1 if a temperature control device (not shown) is located in thrust bearing element 6, and for this reason according to the invention the temperature control device is located in the sealing bar. Aligning elements 8 are comprises an actuating element 8a and a detent element 8b. Aligning element 8 has the form of a set screw, actuating element 8a has the form of a hexagon screw head, detent element 8b has the form of a locknut, wherein one side of the locknut is screwed onto the leg of the set screw, the set screw is screwed into the sealing bar, and the other side of the locknut is braced against the sealing bar, thus retaining the set screw in its current position. In addition, each of the fastening elements 7 exerts a clamping force 11 on thrust bearing element 6 and sealing bar 1. Aligning elements 8 exert a force 12 in the opposite direction to said clamping force 11 for aligning sealing bar 1 with thrust bearing element 6, that is to say for adjusting notional line 10.

FIG. 3 shows a number of variants of an aligning element. FIG. 3a shows an aligning element with a screw device 8l. Screw device has a threaded section 8ld which engages with the sealing bar (not show) for the purpose of aligning it and is braced against bracing surface 8lc, which is aligned normally with screw axis 8le, on the thrust bearing element (not shown). A detent device, in this case a locknut 8lb, is also arranged on threaded section 8ld. Locknut 8lb is engaged on threaded section 8ld and is braced against the sealing bar to keep aligning element 8l in position. When the sealing bar is aligned, a turning moment is applied to screw device 8l via the actuating element, in this case with a hexagonal profile 8la. The rotation causes thereby causes the screw device to shift its position in the direction of screw axis 8le relative to the sealing bar due to the pitch of the thread. This change in position causes a force to be applied between the sealing bar and the thrust bearing element via contact surface 8lc and threaded section 8ld to align the sealing bar. When the target alignment of the sealing bar has been reached, the position of aligning element 8l is secured with locknut 8lb.

FIG. 3b shows an aligning element that works on the principle of movable wedge elements. In this context, said aligning element 8ll comprises a first wedge element 8llf and a second wedge element 8llg. Element 8ll also comprises an actuating screw 8lld with a hexagonal actuating element 8lla for actuating said element. Unintentional alteration of the position of wedge elements 8llf and 8llg is prevented by a locknut device 8llb. The threaded section of actuating screw 8lld is engaged in the sealing bar (not shown). First wedge element 8llf comprises a contact surface 8llc. With this contact surface, aligning element 8ll is supported on the thrust bearing element (not shown). Second wedge element 8llg also comprises a contact surface 8llc. With this contact surface, aligning element 8ll is supported on the sealing bar (not shown). Thus, a force for aligning the sealing bar device is produced by shifting the first and second wedge elements.

FIG. 3c shows two different views (front and side view) of an eccenter aligning element 8lll, wherein said device works according to the eccenter principle. Such an aligning element 8lll comprises a shaft with two first diameters 8llla and a second diameter 8lllb, wherein said first and said second diameters are not concentric but are arranged eccentrically relative to one another about space E. In order to align sealing bar device 1, a turning moment about eccenter axis 8llle is exerted on aligning element 8lll. For this purpose, aligning element 8lll comprises a polygonal profile 8lllc. Aligning element 8lll is braced with the outer surface 8lllf of second diameter 8lllb on thrust bearing element 6. When the desired alignment of sealing bar 1 is reached, further rotation of aligning element 8lll is blocked by clamping screw 8llld, thereby preventing the aligning element from being moved out of position unintentionally.

FIGS. 3dl and 3dll show two aligning elements that work according to the lever principle, wherein one aligning element according to FIG. 3dl works according to the double lever or knee lever principle, and aligning element according to FIG. 3dll works according to the single lever principle. An aligning element according to the double lever principle comprises a first lever device 8lVa and a second lever device 8lVb, first lever device 8lVa being mounted rotatably on the sealing bar, and second lever device 8lVb being mounted in a contact arrangement 8lVc. Contact arrangement 8lVc comprises a contact surface 8lVd auf, wherein this is in contact with the thrust bearing element (not shown). This aligning element further comprises an actuating screw 8lVe. Actuating screw 8lVe, which essentially serves as hinged connection point between the first and second lever devices, is used to alter the angular position of the aligning element, thereby generating a force for alignment between the sealing bar and the thrust bearing element. Once the sealing bar is aligned in the desired position, the rotation of actuating screw 8lVe may be blocked using detent device 8lVf, and in this way unintentional movement of the aligning element may be prevented.

The single lever alignment means comprises a lever device 8Va, which is connected rotatably and in hinged manner to sealing bar 1. The other end of lever device 8Va is mounted rotatably in contact device 8Vc. Actuating screw 8Ve is used to alter the angular position of lever device 8Va, thereby exerting a force for alignment of sealing bar 1 with the thrust bearing element (not shown) via contact surface 8Vd. Unintentional shifting of the position of actuating screw 8Ve may be prevented using locknut device 8Vf.

List of reference signs

| | |
|---|---|
| 1 | Pressure element/sealing bar |
| 2 | Pressure surface |
| 3 | Temperature control device |
| 3a | Recess for the temperature control device |
| 4a | Recess for accommodating a fastening element |
| 4b | Recess for accommodating an aligning element |
| 5 | Pressure device |
| 6 | Thrust bearing element |
| 7 | Fastening element |
| 8 | Aligning element |
| 8a | Actuating element |
| 8b | Detent element |
| 8I | Aligning element with screw device |
| 8Ia | Hexagonal actuating element |
| 8Ib | Locknut device |
| 8Ic | Contact surface |
| 8Id | Threaded section |
| 8Ie | Screw centre line |
| 8II | Aligning element wedge elements |
| 8IIa | Hexagonal actuating element |
| 8IIb | Locknut device |
| 8IIc | Contact surface |
| 8IId | Actuating screw |
| 8IIg | Second wedge element |
| 8IIf | First wedge element |
| 8III | Aligning element with eccenter device |
| 8IIIa | First diameter |
| 8IIIb | Second diameter |
| 8IIIc | Polygonal shape |
| 8IIId | Clamping screw |
| 8IIIe | Eccenter axis |
| 8IIIf | Casing surface |
| 8IVa | First lever device |
| 8IVb | Second lever device |
| 8IVc | Contact device |
| 8IVd | Contact surface |
| 8IVe | Actuating screw |
| 8IVe | Detent device |
| 8Va | Lever device |
| 8Vc | Contact device |
| 8Vd | Contact surface |
| 8Ve | Actuating screw |
| 8Vf | Locknut device |
| 9 | Gap |
| 10 | Target alignment, notional line |
| 11 | Clamping force |
| 12 | Alignment force |

1-12. (canceled)

13. A pressure device for use in the production of electrochemical energy storage devices, to bring a force to bear on a first foil section of said energy storage devices during said production, the device comprising:
a thrust bearing element;
a pressure element configured to be braced on said thrust bearing element, wherein said pressure element has a cross-sectional area and a lengthwise extension arranged orthogonally to said cross-sectional area, and wherein the dimensions of said cross-sectional area are small compared with said lengthwise extension;
a fastening element configured to fasten the pressure element to the thrust bearing element, wherein the fastening element is configured to exert a clamping force on said pressure element and said thrust bearing element during said fastening; and
an aligning element, wherein at least parts of said pressure element are separated from said thrust bearing element by said aligning element, wherein said aligning element is configured to be connected in form-fit manner to said pressure device.

14. The pressure device according to claim 13, wherein said aligning element is joined in form-fit connection to said thrust bearing element.

15. The pressure device according to claim 13, wherein said aligning element is joined in form-fit connection to pressure element.

16. The pressure device according to claim 13, wherein said aligning element comprises a first surface section that cooperates with said pressure element, and a second surface section that cooperates with said thrust bearing element, and an actuating element, wherein the space between said first surface section and said second surface section is configured to be altered by a rotary movement of said actuating element.

17. The pressure device according to claim 16, wherein the aligning element comprises a threaded section and a bracing section, wherein the threaded section is joined in a form-fit connection with the pressure element or the thrust bearing element, and the bracing section is braced indirectly or directly on the respective other of the two elements.

18. The pressure device according to claim 17, wherein
the aligning element comprises an actuating section configured as an actuating element to transmit an actuating force and comprising an essentially polygonal profile, and
the bracing section is constructed as a surface section that is orthogonal to an axis of symmetry of said threaded section.

19. The pressure device according to 16, wherein
the aligning element comprises a first and a second cylindrical section, wherein the two said cylindrical sections are not arranged concentrically with one another,
the first cylindrical section is mounted rotatably in said pressure element or said thrust bearing element, and
the second cylindrical section is braced indirectly or directly on the respective other of the two devices.

20. The pressure device according to 16, wherein the aligning element comprises a wedge element, wherein
the wedge element has a first wedge surface, a second wedge surface and a wedge support surface,
the wedge support surface cooperates indirectly or directly with the pressure element or the thrust bearing element, and
the first wedge surface is mounted so as to be movable relative to the respective other of the two elements.

21. The pressure device according to 16, wherein
the aligning element comprises a lever device connect to the pressure element or the thrust bearing element by a swivel joint, and
the aligning element has a lever bracing surface, wherein the level bracing surface is braced indirectly or directly on the respective other of the two devices.

22. The pressure device according to claim 13, wherein the aligning element comprises a detent device configured to prevent an actuating element from making a rotating movement.

23. The pressure device according to claim 13, further comprising a temperature control device, wherein at least a portion of the temperature control device is arranged inside the pressure element.

24. A method for aligning a pressure element in a pressure device according to claim 13, the method comprising:
recording an initial position of the pressure element;
altering said initial position by actuating at least one aligning element until a target position of the pressure element is reached; and
securing the aligning element in the actuated position.
